(19) United States
(12) Patent Application Publication
(10) Pub. No.: US 2026/0104844 A1
(43) Pub. Date: Apr. 16, 2026

(54) SOUND EFFECT CONTROL METHOD, ELECTRONIC DEVICE AND STORAGE MEDIUM

(71) Applicant: AAC Acoustic Technologies (Shanghai) Co., Ltd., Shanghai (CN)

(72) Inventors: Yangzhen Chen, Shanghai (CN); Lijian Ye, Shanghai (CN); Hongxing Wang, Shanghai (CN)

(21) Appl. No.: 19/006,325

(22) Filed: Dec. 31, 2024

Related U.S. Application Data
(63) Continuation of application No. PCT/CN2024/124954, filed on Oct. 15, 2024.

(51) Int. Cl. G06F 3/16

(52) U.S. Cl. CPC G06F 3/165

(57) ABSTRACT

A sound effect control method includes: determining an activation filter group and a to-be-activated filter group in a sound effect module; determining an activation filter group and a to-be-activated filter group in a sound effect module; determining at least one intermediate transition filter group according to the activation filter group and the to-be-activated filter group; and stage-by-stage transitioning the activation filter group to the to-be-activated filter group through the at least one intermediate transition filter group in the sound effect module. With the present disclosure, the transition process from the activation filter group to the to-be-activated filter group is smoother, thereby improving the smoothness of sound effect transition during environment changes. Meanwhile, in the transition process from the activation filter group to the to-be-activated filter group, controllability of sound effect transition time can be obtained only by controlling the switching time of the intermediate transition filter group.

### TECHNICAL FIELD

The present disclosure relates to the technical field of audios, and in particular to a sound effect control method, an electronic device and a storage medium.

### BACKGROUND

With the development of technology, in order to improve user's experience, at present, there are intelligent devices that can automatically adapt audio playback effects according to the surrounding environment. In the related art, in the process of intelligent devices automatically adapting audio according to the surrounding environment, environmental scenario recognition and fusion are mainly achieved through machine learning, deep learning, and other traditional methods to learn patterns and regularities from the collected sensor data sets. When the device is placed in different scenarios, it can automatically recognize the type of environmental scenario and then adapt different sound effect parameters according to the different scenario types.

However, when users switch scenarios, there are technical problems of smooth sound effects switching and uncontrollable switching time in related art.

### SUMMARY

Embodiments of the present disclosure provide a sound effect control method, an electronic device, and a storage medium, which improve smoothness of sound effect transition and controllability of sound effect transition time when the environment changes.

A sound effect control method includes:
determining an activation filter group and a to-be-activated filter group in a sound effect module;
determining at least one intermediate transition filter group according to the activation filter group and the to-be-activated filter group; and
stage-by-stage transitioning the activation filter group to the to-be-activated filter group through the at least one intermediate transition filter group in the sound effect module.

As an improvement, the determining at least one intermediate transition filter group according to the activation filter group and the to-be-activated filter group, includes:
obtaining first parameter information of each filter of a same type included in the activation filter group and second parameter information of each filter of a same type included in the to-be-activated filter group, wherein filters of a same type included in the to-be-activated filter group are in a one-to-one correspondence with filters of a same type included in the activation filter group;
determining third parameter information of a corresponding filter of the intermediate transitional filter group according to the corresponding first parameter information and second parameter information;
determining each filter of the intermediate transitional filter group in the sound effect module according to the third parameter information; and
the stage-by-stage transitioning the activation filter group to the to-be-activated filter group through the at least one intermediate transition filter group in the sound effect module, includes:
stage-by-stage transitioning each filter of the activation filter group to a corresponding filter of the to-be-activated filter group through a filter corresponding to at least one of the intermediate transition filter groups.

As an improvement, the sound effect module includes M types of filters, and M is an integer greater than 0; the activation filter group includes at least one of the M types of filters; the to-be-activated filter group includes at least one of the M types of filters; and before the obtaining first parameter information of each filter included in the activation filter group and second parameter information of each filter included in the to-be-activated filter group, the method further includes:
for one of the filter types, adding a first virtual filter of a same type to the activation filter group when a number of filters included in the activation filter group is smaller than a number of filters included in the to-be-activated filter group; or, adding a second virtual filter of a same type to the to-be-activated filter group when a number of filters included in the activation filter group is greater than a number of filters included in the to-be-activated filter group, so that filters of a same type included in the to-be-activated filter group are in a one-to-one correspondence with filters of a same type included in the activation filter group.

As an improvement, the first parameter information includes a first parameter value of each filter included in the activation filter group, and the second parameter information includes a second parameter value of each filter included in the to-be-activated filter group; the third parameter information includes a third parameter value of each filter included in the intermediate transition filter group; and each of the first parameter value, the second parameter value, and the third parameter value is one of a cut-off frequency point, a gain, a Q value, and a filter order; and
the determining third parameter information of a corresponding filter of the intermediate transitional filter group according to the corresponding first parameter information and second parameter information, includes:
when the first parameter value, the second parameter value, and the third parameter value are all cut-off frequency points, gains, or Q values, for filters corresponding to the activation filter group and the to-be-activated filter group, performing a linear operation or an exponent operation on the first parameter value and the second parameter value according to the number of intermediate filter groups to obtain the third parameter value of the filter corresponding to each of the intermediate transition filter groups.

As an improvement, the first parameter information of each filter included in the activation filter group includes different first parameter values, the second parameter information of each filter included in the to-be-activated filter group includes different second parameter values, and the third parameter information of each filter included in the intermediate transition filter group includes different third parameter values.

As an improvement, the determining third parameter information of a corresponding filter of the intermediate transitional filter group according to the corresponding first parameter information and second parameter information, further includes:
for filters corresponding to the activation filter group and the to-be-activated filter group, determining a number of steps required during transition based on a filter order of a filter corresponding to the activation filter group and a filter order of a filter corresponding to the to-be-activated filter group when the first parameter value, the second parameter value, and the third parameter value are all filter orders; and
uniformly dividing, according to the number of steps, corresponding filters in the intermediate filter groups into each step in order or in reverse order based on the size of the step, to determine a filter order of the corresponding filter of each of the intermediate filter groups.

As an improvement, the stage-by-stage transitioning the activation filter group to the to-be-activated filter group through the at least one intermediate transition filter group in the sound effect module, includes:
stage-by-stage transitioning the activation filter group to the to-be-activated filter group through the at least one intermediate transition filter group in the sound effect module; wherein in each stage of transition process, the filter group before transition and the filter group after transition perform fade in-out transition according to a preset number of processing frames.

As an improvement, in each stage of transition process, performing the fade in-out transition on the filter group before the transition and the filter group after the transition according to a preset number of processing frames includes:
in each stage of the transition process, determining an attenuation coefficient of each processing frame of processing frames with the preset number before the transition and an enhancement coefficient of the filter group after the transition, wherein the attenuation coefficient gradually decreases and the enhancement coefficient gradually increases;
filtering an input processing frame through the filter group before the transition to obtain a first filtered frame, and filtering the input processing frame through the filter group after the transition to obtain a second filtered frame; and
attenuating the first filtered frame according to the attenuation coefficient, and enhancing the second filtered frame according to the enhancement coefficient; and superposing the attenuated first filtered frame and the enhanced second filtered frame according to sample points to obtain a filtered frame corresponding to the processing frame.

An electronic device, comprising:
at least one processor; and
a memory communicating with the at least one processor;
wherein the memory stores instructions executable by the at least one processor, and the instructions are executed by the at least one processor to enable the at least one processor to perform the sound effect control method as described above.

A computer readable storage medium storing a computer program, wherein the computer program, when executed by a processor, implements the sound effect control method as described above.

The technical solutions provided by the embodiments of the present disclosure have at least the following advantages.

According to the embodiments of the present disclosure, after determining the activation filter group and the to-be-activated filter group, at least one intermediate transition filter group is determined according to the activation filter group and the to-be-activated filter group. The activation filter group is stage-by-stage transitioned to the to-be-activated filter group through at least one intermediate transition filter group, so that the transition process from the activation filter group to the to-be-activated filter group is smooth, thereby improving the smoothness of sound effect transition during environment changes. Meanwhile, in the transition process from the activation filter group to the to-be-activated filter group, controllability of sound effect transition time can be obtained only by controlling the switching time of the intermediate transition filter group.

### BRIEF DESCRIPTION OF DRAWINGS

Many aspects of the exemplary embodiment can be better understood with reference to following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic flowchart of a sound effect control method according to some embodiments of the present disclosure;

FIG. 2 is a schematic flowchart of a sound effect control method according to some embodiments of the present disclosure;

FIG. 3 is a schematic flowchart of a sound effect control method according to some embodiments of the present disclosure;

FIG. 4 is a schematic flowchart of a sound effect control method according to some embodiments of the present disclosure;

FIG. 5 is a schematic flowchart of a sound effect control method according to some embodiments of the present disclosure;

FIG. 6 is a schematic diagram of a filter order transitioning from 2nd order to 6th order through 20 stages;

FIG. 7 is a schematic flowchart of a sound effect control method according to some embodiments of the present disclosure;

FIG. 8 is a process diagram of an activation filter group transitioning to a to-be-activated filter group through a plurality of intermediate transition filter groups;

FIG. 9 is a schematic flowchart of sub-steps of step 603 according to some embodiments of the present disclosure;

FIG. 10 is a schematic diagram of a fade in-out mechanism performed by two groups of filters on a processing frame in one process of the transition according to some embodiments of the present disclosure; and

FIG. 11 is a schematic structural diagram of an electronic device according to some embodiments of the present disclosure.

### DESCRIPTION OF EMBODIMENTS

In order to more clearly illustrate objectives, technical solutions, and advantages of the embodiments of the present disclosure, the technical solutions in the embodiments of the present disclosure are clearly and completely described in details with reference to the drawings. However, those of ordinary skill in the art will appreciate that in various embodiments of the present disclosure, numerous technical details are set forth for the reader to better understand the present disclosure. However, even without these technical details and various variations and modifications based on following embodiments, the technical solutions claimed in the present disclosure can still be implemented. The following embodiments are divided for ease of description, and should not constitute any limitation on specific embodiments of the present disclosure, and the embodiments can be mutually incorporated by reference without contradiction.

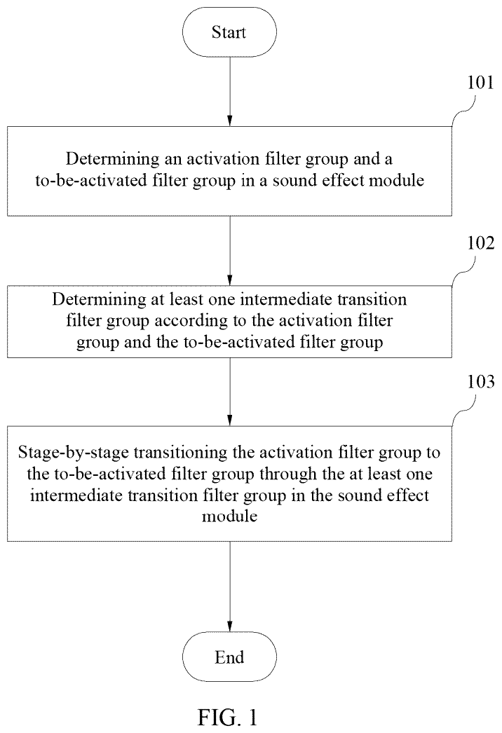

An embodiment of the present disclosure relates to a sound effect control method. As shown in FIG. 1, the sound effect control method includes the following steps.

Step 101: an activation filter group and a to-be-activated filter group are determined in a sound effect module.

The sound effect module is the most important module for constructing the basic sound effect. The equalizer is one of the most commonly used sound effect modules, which can be implemented in both time domain and frequency domain. In a consumer electronic product, due to the limitation of digital signal processing (DSP) computing power, equalizers generally use time-domain infinite impulse response (IIR) filter groups for sound effect equalization. Therefore, in order to reduce DSP computing power, the sound effect module used in this embodiment is an equalizer, which uses an IIR filter. However, in other embodiments, the sound effect module may also be an equalizer using a finite unit impulse response (FIR) filter in frequency domain, or may be another sound effect module other than an equalizer, such as a dynamic range control module.

In some embodiments, the sound effect module is an equalizer composed of IIR filters for illustration, and one equalizer composed of IIR filters is composed of 5 types of filters, including: Low-Pass Filter (LPF), High-Pass Filter (HPF), Peak Filter/Notch Filter, Low Shelf FILTER, High Shelf Filter. A parameter of an IIR filter may be defined as: a type (the 5 basic filter types defined above), a cut-off frequency fc, a gain, a Q value, an order, and an enable switch. The cut-off frequency, the gain, the Q value, and the order of the filter are all adjustable. The enable switch indicates whether the filter performs filtering. The filter performing filtering is in an enabled state, and the filter not performing filtering is in a disabled state.

The number of filters of each type in the equalizer can be more than one or null. The types and quantities of filters that need to be enabled vary in different environments. The sound effect control method in this embodiment refers to switching from one group of activation filters (a plurality of different types of IIR filters used in a current scenario) to another group of pending filters (a plurality of different types of IIR filters that need to be used in a changed scenario) when the scenario changes. The previous group of filters and the next group of filters may be completely different, that is, different filter numbers, types, filter parameters are different.

In an actual application, according to the five types of filters defined above, filters in the activation filter group and the to-be-activated filter group are traversed respectively. The activation filter group is divided into 5 groups according to filter types, and the to-be-activated filter group is divided into 5 groups according to filter types. The activation filter group and the to-be-activated filter group may include all filter types or may include only a plurality of filter types. If the filter group does not include a filter type, a corresponding group is null.

The following examples illustrate the statistics of the number of various types of filters included in the activation filter group and the to-be-activated filter group. For example, the activation filter group includes 1 low-pass filters, 2 high-pass filters, 10 Peak/Notch filters, 0 low shelf filters, and 1 high shelf filters, while the to-be-activated filter group includes 0 low-pass filters, 1 high pass filter, 15 Peak/Notch filters, 1 low shelf filter, and 0 high shelf filter.

In some embodiments, the activation filter group is determined according to the environmental parameter before the change, and the to-be-activated filter group is determined according to the environmental parameter after the change. In some embodiments, whether the environmental parameter around the electronic product changes is detected in real time, and when the environmental parameter around the electronic product changes, the changed environmental parameter is obtained. The to-be-activated filter group that needs to be used is determined in the sound effect module according to the changed environmental parameter. The sound effect module currently has the activation filter group determined according to the environmental parameter before the change. The activation filter group is in an enabled state. After determining the activation filter group and the to-be-activated filter group in the sound effect module, transition from the activation filter group to the to-be-activated filter group is completed in the sound effect module.

Step 102: at least one intermediate transition filter group is determined according to the activation filter group and the to-be-activated filter group.

In some embodiments, after determining the activation filter group and the to-be-activated filter group in the sound effect module, at least one intermediate transition filter group that needs to be used to transit the activation filter group to the to-be-activated filter group is determined according to the activation filter group and the to-be-activated filter group. There may be one or more intermediate transition filter groups, which is determined according to an actual smoothness of sound effect transition. The more intermediate transition filter groups are, the smoother the transition of the sound effect will be. The fewer intermediate transition filter groups are, the smoother the transition of the sound effect will be. The number of the intermediate transition filter groups may be set in advance. After determining the number of the intermediate transition filter groups, the transition from the activation filter group to the to-be-activated filter group is completed in the sound effect module according to the intermediate transition filter group.

Step 103: the activation filter group is stage-by-stage transitioned to the to-be-activated filter group through the at least one intermediate transition filter group in the sound effect module.

After the sound effect module determines the intermediate transition filter group, the activation filter is first transitioned to a first intermediate transition filter group. Then transitioned from the first intermediate transition filter group to a second intermediate transition filter group, and so on until the last intermediate transition filter group transitions to the to-be-activated filter group, thereby completing the whole process of transitioning from the activation filter group to the to-be-activated filter group stage by stage.

It is not possible to switch directly from the activation filter group to the to-be-activated filter group. Switching directly will result in uneven sound effect and create a sense of abruptness. Therefore, it is necessary to stage-by-stage transition and switch each filter parameter in the activation filter group in a stepwise manner. Multi-stage switching transition is carried out from the activation filter group to the to-be-activated filter group, thereby stage-by-stage changing the sound and avoiding frustration.

In the related art, when the user switches the scenario to change the environment around the electronic product, the related art has the technical problems of unsmooth switching and uncontrollable switching time. To solve this problem, according to the embodiments of the present disclosure, after determining the activation filter group and the to-be-activated filter group, at least one intermediate transition filter group is determined according to the activation filter group and the to-be-activated filter group. The activation filter group is stage-by-stage transitioned to the to-be-activated filter group through at least one intermediate transition filter group, so that the transition process from the activation filter group to the to-be-activated filter group is smooth, thereby improving the smoothness of sound effect transition during environment changes. Meanwhile, in the transition process from the activation filter group to the to-be-activated filter group, controllability of sound effect transition time can be obtained only by controlling the switching time of the intermediate transition filter group.

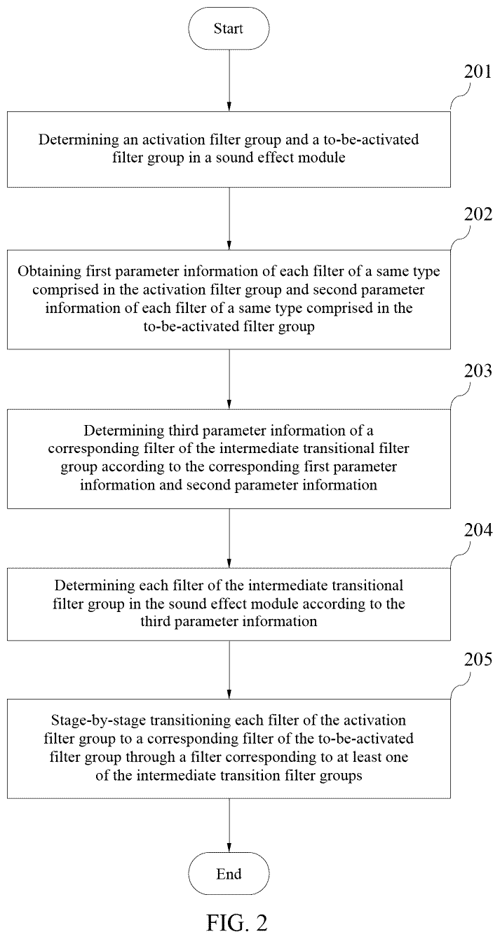

Another embodiment of the present disclosure relates to a sound effect control method. As shown in FIG. 2, the sound effect control method includes the following steps.

Step 201: an activation filter group and a to-be-activated filter group are determined in a sound effect module.

Step 201 is substantially the same as step 101, which is not elaborated herein to avoid repetition.

The following step 201, step 203 and step 204 are sub-steps of determining at least one intermediate transition filter group according to the activation filter group and the to-be-activated filter group in step 102. The step 201, step 203 and step 204 are as follows.

Step 202: first parameter information of each filter of a same type included in the activation filter group and second parameter information of each filter of a same type included in the to-be-activated filter group are obtained.

Filters of the same type included in the to-be-activated filter group are in one-to-one correspondence with filters of the same type included in the activation filter group.

In order to enable the activation filter group to transition to the to-be-activated filter group better, it is necessary to make filters of the same type included in the to-be-activated filter group are in one-to-one correspondence with filters of the same type included in the activation filter group. That is, filters included in the activation filter group are in one-to-one correspondence with filters of the same type included in the to-be-activated filter group in quantity. A filter of the activation filter group is the same as a corresponding filter of the to-be-activated filter group.

In order to obtain the intermediate transition filter group, relevant information of each filter of the intermediate transition filter group needs to be obtained. Therefore, in some embodiments, first parameter information of each filter of the activation filter group and second parameter information of each filter of the to-be-activated filter group are obtained firstly, and then third parameter information of each filter of the intermediate transition filter group is obtained according to the corresponding first parameter information and second parameter information. In this case, types of filters corresponding to the first parameter information, the second parameter information, and the third parameter information are the same.

Step 203: third parameter information of a corresponding filter of the intermediate transitional filter group is determined according to the corresponding first parameter information and second parameter information.

When obtaining the third parameter information of each filter of the intermediate transition filter group, the filter corresponding to the first parameter information, the filter corresponding to the second parameter information, and the filter corresponding to the third parameter information are of the same type. That is, under the corresponding filters of the same type, the third parameter information of the corresponding filter of the intermediate transition filter group is determined according to the first parameter information and the second parameter information. Therefore, during transition, transition is performed according to the corresponding filters of the same type, thereby improving the smoothness of sound effect transition.

Step 204: each filter of the intermediate transitional filter group in the sound effect module is determined according to the third parameter information.

After obtaining the third parameter information, each filter of the intermediate transition filter group may be determined in the sound effect module based on the third parameter information, and the type of the filter is the same as the type of the filter corresponding to the first parameter information and the type of the filter corresponding to the second parameter information. Each filter of the intermediate transition filter group is in a one-to-one correspondence with each filter of the activation filter group, and is also in a one-to-one correspondence with each filter of the to-be-activated filter group.

The following step 205 is a specific implementation of step 103. Step 205 is as follows.

Step 205: each filter of the activation filter group is stage-by-stage transitioned to a corresponding filter of the to-be-activated filter group through a filter corresponding to at least one of the intermediate transition filter groups.

In some embodiments, all the filters of the activation filter group, all the filters of the to-be-activated filter group, and all the filters of the intermediate transition filter group are in one-to-one correspondence in number and type, so as to perform transition according to the corresponding filters of the same type in the step-by-step transition process, thereby improving the smoothness of the sound effect transition.

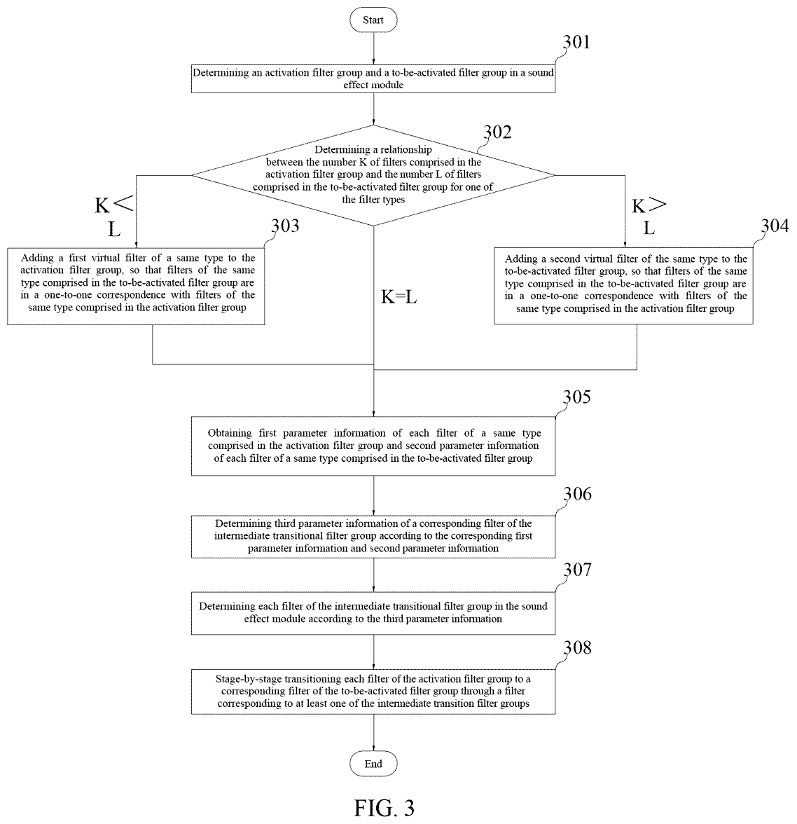

Another embodiment of the present disclosure relates to a sound effect control method. As shown in FIG. 3, the sound effect control method includes the following steps.

Step 301: an activation filter group and a to-be-activated filter group are determined in a sound effect module.

The sound effect module includes M types of filters, where M is an integer greater than 0. The activation filter group includes at least one of the M types of filters, and the to-be-activated filter group includes at least one of the M types of filters. The number of filters of the same type included in the activation filter group and that included in the to-be-activated filter group may be the same or different.

Step 302: a relationship between the number K of filters included in the activation filter group and the number L of filters included in the to-be-activated filter group is determined for one of the filter types.

If the quantity K of filters included in the activation filter group is smaller than the quantity L of filters included in the to-be-activated filter group, step 303 is performed. If the quantity K of filters included in the activation filter group is greater than the quantity L of filters included in the to-be-activated filter group, step 304 is performed. If the quantity K of filters included in the activation filter group is equal to the quantity L of filters included in the to-be-activated filter group, step 305 is performed.

Step 303: a first virtual filter of the same type is added to the activation filter group, so that filters of the same type included in the to-be-activated filter group are in a one-to-one correspondence with filters of the same type included in the activation filter group.

Step 304: a second virtual filter of the same type is added to the to-be-activated filter group, so that filters of the same type included in the to-be-activated filter group are in a one-to-one correspondence with filters of the same type included in the activation filter group.

For one of the filter types, if a number of filters included in the activation filter group is smaller than a number of filters included in the to-be-activated filter group, a first virtual filter of a same type is added to the activation filter group. If a number of filters included in the activation filter group is greater than a number of filters included in the to-be-activated filter group, a second virtual filter of a same type is added to the to-be-activated filter group. Therefore, filters included in the to-be-activated filter group are in a one-to-one correspondence with filters included in the activation filter group.

Since the filters included in the activation filter group may not correspond to the filters included in the to-be-activated filter group in number and type, in order to solve this problem, in some embodiments, for one filter type, the number of filters of the activation filter group and the number of filters of the to-be-activated filter group are obtained respectively. The first parameter information of each filter of the activation filter group includes the filter types. The second parameter information of each filter of the to-be-activated filter group includes the filter types. Therefore, the number of each type of filter included in the activation filter group may be determined according to the first parameter information of each current filter of the activation filter group. Meanwhile, the number of each type of filter included in the to-be-activated filter group may be determined according to the second parameter information of each current filter of the to-be-activated filter group.

Then, for one type of filter, the number of filters of the type included in the activation filter group is compared with the number of filters of the type included in the to-be-activated filter group. When the number of filters of the type included in the activation filter group is the same as the number of filters of the type included in the to-be-activated filter group, step 305 is performed directly without any processing. Then, first parameter information of each filter included in the activation filter group and second parameter information of each filter included in the to-be-activated filter group are obtained. If the number of filters of the type included in the activation filter group is smaller than the number of filters of the type included in the to-be-activated filter group, a first virtual filters of a same type is added to the activation filter group. Therefore, filters included in the to-be-activated filter group are in a one-to-one correspondence with filters included in the activation filter group. That is, a number of newly added first virtual filters is a difference between a number of filters of the type included in the activation filter group and a number of filters of the type included in the to-be-activated filter group. If the number of filters of the type included in the activation filter group is greater than the number of filters of the type included in the to-be-activated filter group, a second virtual filter of a same type is added to the to-be-activated filter group. Therefore, filters included in the to-be-activated filter group are in a one-to-one correspondence with filters included in the activation filter group. That is, a number of newly added second virtual filters is a difference between a number of filters of the type included in the activation filter group and a number of filters of the type included in the to-be-activated filter group. When the number of filters of the type included in the activation filter group is smaller than the number of filters of the type included in the to-be-activated filter group, it indicates that the activation filter group does not have a filter of the type. Therefore, it is necessary to construct some “inactive” first virtual filters in the activation filter group, and set the parameters of the first virtual filters. For example, when the first virtual filter is a high-pass filter and a low shelf filter, its cut-off frequency is set to be 10 Hz, the order is set to be 2, the Q value is set to be 1, and the gain is set to be 0. When the first virtual filter is a low-pass filter and a high shelf filter, its cut-off frequency of the first virtual filter is set to be 20000 Hz, the order is set to be 2, the Q value is set to be 1, and the gain is set to be 0. When the first virtual filter is a Peak/Notch filter, its order is set to be 2, the Q value is set to be 1, the gain is set to be 0. The cut-off frequency of the first virtual filter is the same as the cut-off frequency of a target filter of the same type corresponding to the to-be-activated filter group. That is, the cut-off frequency of the first virtual filter is the same as the cut-off frequency of a filter corresponding to the to-be-activated filter group.

When the number of filters of the type included in the activation filter group is greater than the number of filters of the type included in the to-be-activated filter group, it indicates that the to-be-activated filter group does not have a filter of the type. Therefore, it is necessary to construct some “inactive” second virtual filters in the to-be-activated filter group, and set the parameters of the second virtual filters. For example, when the second virtual filter is a high-pass filter and a low shelf filter, its cut-off frequency is set to be 10 Hz, the order is set to be 2, the Q value is set to be 1, and the gain is set to be 0. When the second virtual filter is a low-pass filter and a high shelf filter, its cut-off frequency of the second virtual filter is set to be 20000 Hz, the order is set to be 2, the Q value is set to be 1, and the gain is set to be 0. When the second virtual filter is a Peak/Notch filter, its order is set to be 2, the Q value is set to be 1, the gain is set to be 0. The cut-off frequency of the second virtual filter is the same as the cut-off frequency of a target filter of the same type corresponding to the activation filter group. That is, the cut-off frequency of the second virtual filter is the same as the cut-off frequency of a filter corresponding to the activation filter group.

Step 305: first parameter information of each filter of a same type included in the activation filter group and second parameter information of each filter of a same type included in the to-be-activated filter group are obtained.

Filters of the same type included in the to-be-activated filter group are in one-to-one correspondence with filters of the same type included in the activation filter group.

When the activation filter group includes the first virtual filter, obtaining the first parameter information of each filter included in the activation filter group is to obtain the first parameter information of a previous filter in the activation filter group and the first parameter information of the first virtual filter. When the to-be-activated filter group includes the second virtual filter, obtaining second parameter information of each filter included in the to-be-activated filter group is to obtain the second parameter information of a previous filter of the to-be-activated filter group and the second parameter information of the second virtual filter.

Step 306: third parameter information of a corresponding filter of the intermediate transitional filter group is determined according to the corresponding first parameter information and second parameter information.

Step 307: each filter of the intermediate transitional filter group in the sound effect module is determined according to the third parameter information.

Step 308: each filter of the activation filter group is stage-by-stage transitioned to a corresponding filter of the to-be-activated filter group through a filter corresponding to at least one of the intermediate transition filter groups.

Step 301, step 305 to step 308 are substantially the same as step 201 to step 205 in some embodiments, which are not elaborated herein to avoid repetition.

The parameter generation rule of the intermediate transition filter group in this embodiment is as follows.

1. Transition is performed between groups of the same type.

2. If the number of a certain type (such as a high-pass filter exemplified in the above embodiment) of the activation filter group is greater than the number of corresponding types of the to-be-activated filter group, the filters of this type are divided into two parts. The first part is the same number of filters of this type in the activation filter group and the to-be-activated filter group. The second part is the filters in the activation filter group of this type that are more than those in the to-be-activated filter group, which is the transition of the filters from enable to disable.

3. If the number of a certain type (the Peak/Notch filter exemplified in the above embodiment) of the activation filter group is smaller than the number of corresponding types of the to-be-activated filter group, the filters of this type are divided into two parts. The first part is the same number of filters of this type in the activation filter group and the to-be-activated filter group. The second part is the filters in the to-be-activated filter group of this type that are more than those in the activation filter group, which is the transition of the filters from disable to enable.

For the filter types of the first part of the 2nd point and the 3th point, since the number of activation filter groups is the same as the number of to-be-activated filter groups, the intermediate transition filter group linearly or exponentially transitions the cut-off frequency point, the gain, and the Q value.

For the filter types of the second part of the 2nd point, since the to-be-activated filter group does not have filters of this type, it is necessary to construct some “inactive” filter parameters. For the high-pass filter and the Low-shelf filter, its cut-off frequency is 10 Hz, the order is 2, the Q value is 1, and the gain is 0. For the low-pass filter and the High-shelf filter, its cut-off frequency is 20000 Hz, the order is 2, the Q value is 1, and the gain is 0. For the Peak/Notch filter, its cut-off frequency is the same as the cut-off frequency of the extra filters in the activation filter group, the order is 2, Q value is 1, and gain is 0.

For the filter types of the second part of the 3th point, since the activation filter group does not have filters of this type, it is necessary to construct some “inactive” filter parameters. For the high-pass filter and the low-shelf filter, its cut-off frequency is 10 Hz, the order is 2, the Q value is 1, and the gain is 0. For the low-pass filter and the high-shelf filter, its cut-off frequency is 20000 Hz, the order is 2, the Q value is 1, and the gain is 0. For the Peak/Notch filter, its cut-off frequency is the same as the cut-off frequency of the extra filters in the activation filter group, the order is 2, Q value is 1, and gain is 0.

In some embodiments, after determining the activation filter group and the to-be-activated filter group, if the number of filters of the same type in the activation filter group does not correspond to the number of filters of the same type in the to-be-activated filter group, virtual filters, including the first virtual filter and the second virtual filter, are added according to the number of filters of each type in the activation filter group and the to-be-activated filter group, so that filters of the same type in the to-be-activated filter group are in one-to-one correspondence with filters of the same type in the activation filter group. Therefore, transition is performed according to the one-to-one corresponding filters of the same type in the step-by-step transition process, thereby improving the smoothness of the sound effect transition.

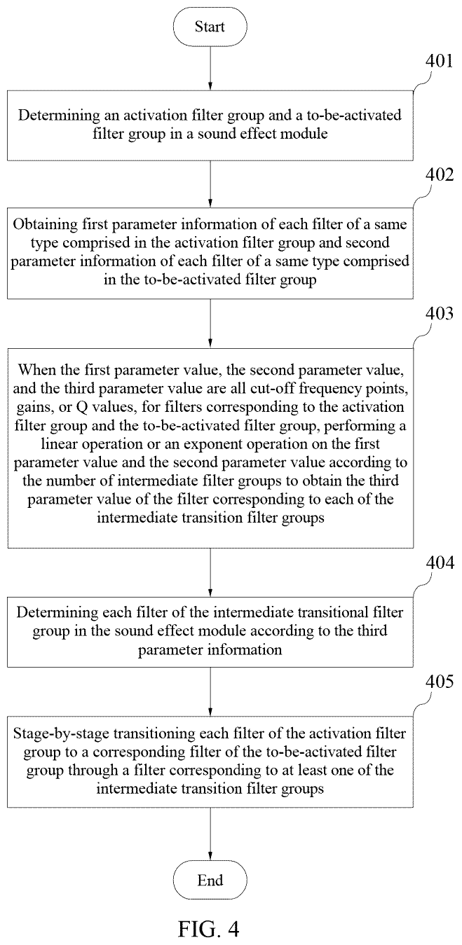

Another embodiment of the present disclosure relates to a sound effect control method. As shown in FIG. 4, the sound effect control method includes the following steps.

Step 401: an activation filter group and a to-be-activated filter group are determined in a sound effect module.

Step 402: first parameter information of each filter of a same type included in the activation filter group and second parameter information of each filter of a same type included in the to-be-activated filter group are obtained.

Filters of the same type included in the to-be-activated filter group are in one-to-one correspondence with filters of the same type included in the activation filter group.

In some embodiments, the first parameter information includes the first parameter value of each filter included in the activation filter group. The second parameter information includes the second parameter value of each filter included in the to-be-activated filter group. The third parameter information includes a third parameter value of each filter included in the intermediate transition filter group. The first parameter value, the second parameter value, and the third parameter value are all one of a cut-off frequency point, a gain, a Q value, and a filter order. For example, if the first parameter value is the cut-off frequency point, the corresponding second parameter value, and the corresponding third parameter value are also the cut-off frequency point. If the first parameter value is the gain, the corresponding second parameter value, and the corresponding third parameter value are also the gain. If the first parameter value is the Q value, the corresponding second parameter value, and the corresponding third parameter value are also the Q value. If the first parameter value is the filter order, the corresponding second parameter value, and the corresponding third parameter value are also the filter order.

Step 403: when the first parameter value, the second parameter value, and the third parameter value are all cut-off frequency points, gains, or Q values, for filters corresponding to the activation filter group and the to-be-activated filter group, a linear operation or an exponent operation on the first parameter value and the second parameter value are performed according to the number of intermediate filter groups to obtain the third parameter value of the filter corresponding to each of the intermediate transition filter groups.

For the filters corresponding to the activation filter group and the to-be-activated filter group, the first parameter value and the second parameter value are also of the same type. For the parameter values of the same type, such as the cut-off frequency point, the gain, and the Q value, linear operation or exponent operation are performed on the first parameter value and the second parameter value according to the number of intermediate transition filter groups, to obtain the third parameter value of the corresponding filter of each of the intermediate transition filter groups.

The following uses a linear transition as an example for description, and a linear transition code for the cut-off frequency is as follows:

$$fcDiff = fcInactive - fcActive ;$$

$$fcDelta = fcDiff / ( stepNum - 1 ) ;$$

$$transfc ( j ) = fcActive + ( j - 1 ) * fcDelta ;$$

where fcInactive is the cut-off frequency of a certain filter of the to-be-activated filter group, fcActive is the cut-off frequency of a certain corresponding filter of the activation filter group, j is the index of the intermediate transition filter group, j=1, 2, ⋅ ⋅ ⋅ , stepNum. And the stepNum is the number of the intermediate transition filter groups, transfc (j) is the cut-off frequency of the corresponding filter of the j-th stage of intermediate transition filter group. The cut-off frequency of the corresponding filter of each stage of intermediate transition filter group can be obtained through this algorithm, which is performed on each filter of the activation filter group, to obtain the cut-off frequencies of all the filters of each stage of the intermediate transition filter groups. It is worth mentioning that the linear transition of the Q value and gain of each filter of the intermediate transition filter group is also similar to the linear transition of the cut-off frequency described above.

The first parameter information of each filter included in the activation filter group includes a plurality of different first parameter values, that is, the plurality of different first parameter values are respectively a cut-off frequency point, a gain, and a Q value. The second parameter information of each filter included in the to-be-activated filter group includes a plurality of different second parameter values, that is, the plurality of different second parameter values are respectively a cut-off frequency point, a gain, and a Q value. The third parameter information of each filter included in the intermediate transition filter group includes a plurality of different third parameter values, that is, the plurality of different third parameter values are respectively a cut-off frequency point, a gain, and a Q value. The cut-off frequency point, the gain, and the Q value of each filter included in the intermediate transition filter group are obtained in the foregoing manner, to obtain the cut-off frequency point, the gain, and the Q value of each filter included in the intermediate transition filter group, thereby obtaining the third parameter information of each filter of the intermediate transition filter group.

Step 404: each filter of the intermediate transitional filter group in the sound effect module is determined according to the third parameter information.

Step 405: each filter of the activation filter group is stage-by-stage transitioned to a corresponding filter of the to-be-activated filter group through a filter corresponding to at least one of the intermediate transition filter groups.

Step 401, step 402, step 404 and step 405 of this embodiment are substantially the same as step 201, step 202, step 204 and step 205, which are not elaborated herein to avoid repetition.

In some embodiments, when the first parameter value, the second parameter value, and the third parameter value are all cut-off frequency points, gains, or Q values, the third parameter value of the corresponding filter of each intermediate transition filter group is obtained through linear operation or exponent operation, so that a transition process from the activation filter group to the to-be-activated filter group is relatively smooth, thereby improving smoothness of the sound effect transition when the environment changes.

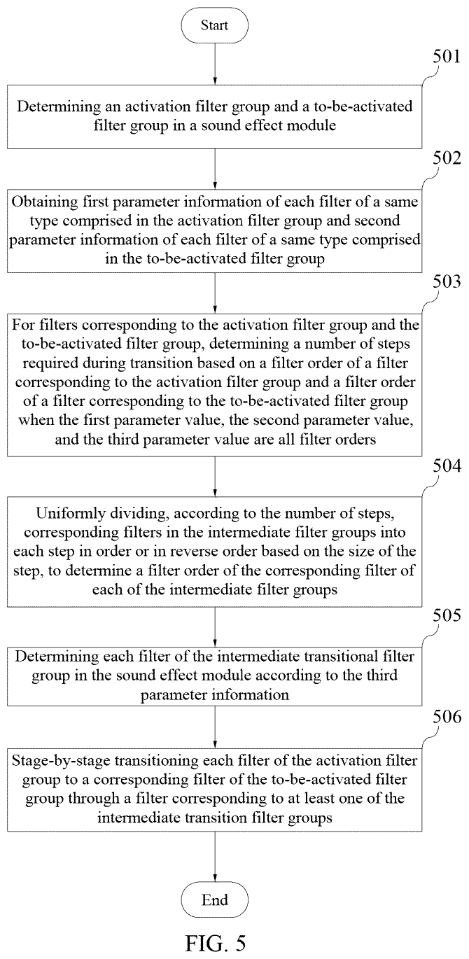

An embodiment of the present disclosure relates to a sound effect control method, and as shown in FIG. 5, the sound effect control method includes the following steps.

Step 501: an activation filter group and a to-be-activated filter group is determined in a sound effect module.

Step 502: first parameter information of each filter of a same type included in the activation filter group and second parameter information of each filter of a same type included in the to-be-activated filter group are obtained.

Filters of the same type included in the to-be-activated filter group are in one-to-one correspondence with filters of the same type included in the activation filter group.

Step 503: when the first parameter value, the second parameter value, and the third parameter value are all filter orders, for filters corresponding to the activation filter group and the to-be-activated filter group, a number of steps required during transition is determined based on a filter order of a filter corresponding to the activation filter group and a filter order of a filter corresponding to the to-be-activated filter group.

Step 504: according to the number of steps, corresponding filters in the plurality of intermediate filter groups are uniformly divided into each step in order or in reverse order based on the size of the step, to determine a filter order of the corresponding filter of each of the plurality of intermediate filter groups.

In addition to the activation filter group and the to-be-activated filter group, the number of intermediate transition filter groups that need to be transitioned is defined as stepNum, which may be adjusted as required. For example, if the stepNum is set to be 20, that is, 20 different intermediate transition filter groups need to be passed when transitioning from the activation filter group to the to-be-activated filter group. The order of the filter is generally an integer value such as 2nd order, 4th order, 6th order, and 8th order, and other integer values. Therefore, in some embodiments, the order of the intermediate transition filter group is adopted in a stepped form.

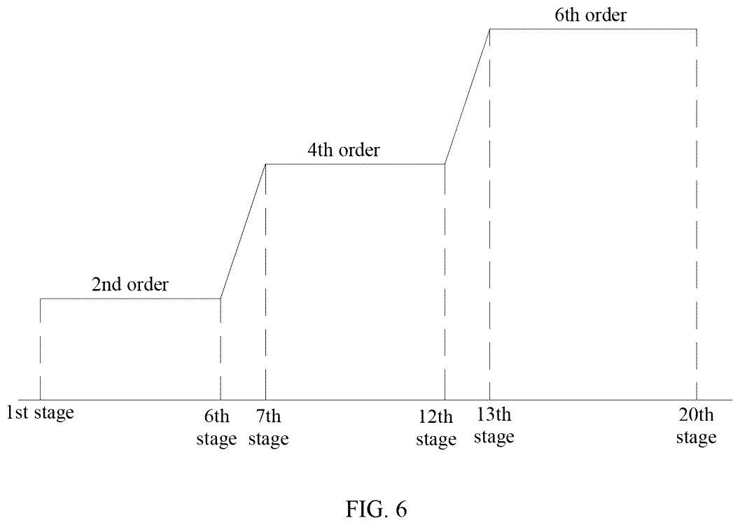

For example, as shown in FIG. 6, which is a schematic diagram of transitioning filter orders from 2nd order through 20 stages to 6th order. In this case, the order of one filter of the activation filter group is 2nd order, the order of the filter of the type corresponding to the to-be-activated filter group is 6th order, and the intermediate transition filter group has 20 stages. For a corresponding intermediate transition filter of the intermediate transition filter group, through the transition of 20 stages, the orders of the intermediate transition filter from 1th to 6th stage is 2nd order; the order number of the intermediate transition filter from 7th to 12th stage is 4th order; and the order number of the intermediate transition filter from 13th to 20th stage is 6th order. Therefore three steps are formed, and the intermediate transition filters corresponding to 20 stages are uniformly distributed at each step.

A calculation process of a filter order of the intermediate transition filter group is as follows. Firstly, an order of a filter of the to-be-activated filter group and an order of a filter corresponding to the activation filter group are determined. Secondly, interpolation is performed within an order range of the two filters. For example, an order 4 is inserted between the orders 2 and 6, steps of the orders 2, 4, and 6 are set to be equal in width, and multiple stages of intermediate transition filters are evenly distributed on each step to determine an order of a corresponding filter of each intermediate transition filter group.

It should be noted that the first parameter information of each filter included in the activation filter group may include a plurality of first parameter values, such as, a cut-off frequency point, a gain, a Q value, and a filter order. The second parameter information of each filter included in the to-be-activated filter group may include a plurality of second parameter values, such as, a cut-off frequency point, a gain, a Q value, and a filter order. The third parameter information of each filter included in the intermediate transition filter group may include a plurality of third parameter values, such as, a cut-off frequency point, a gain, a Q value, and a filter order. Thus, when the third parameter information of the corresponding filter of the intermediate transition filter group is determined based on the corresponding first and second parameter information, the cut-off frequency, gain, Q value, and filter order are calculated using the methods mentioned above to obtain the cut-off frequency, gain, Q value, and filter order of the filter corresponding to the intermediate transition filter group.

Step 505: each filter of the intermediate transitional filter group is determined in the sound effect module according to the third parameter information.

Step 506: each filter of the activation filter group is stage-by-stage transitioned to a corresponding filter of the to-be-activated filter group through a filter corresponding to at least one of the intermediate transition filter groups.

Step 501, step 502, step 505, step 506 of this embodiment are substantially the same as step 201, step 202, step 204, step 205, which are not elaborated herein to avoid repetition.

In some embodiments, when the first parameter value, the second parameter value, and the third parameter value are all filter orders. A filter order of the corresponding filter of each intermediate transition filter group is obtained through an equal-step algorithm, so that a transition process from the activation filter group to the to-be-activated filter group is relatively smooth, thereby improving smoothness of the sound effect transition when the environment changes.

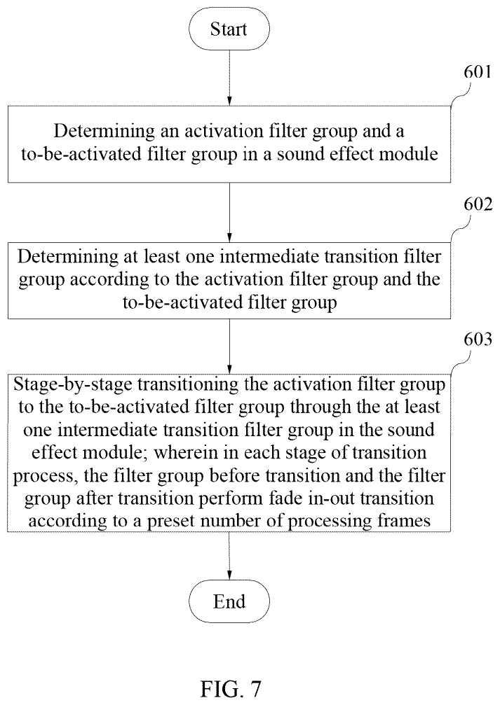

Another embodiment of the present disclosure relates to a sound effect control method. As shown in FIG. 7, the sound effect control method includes the following steps.

Step 601: an activation filter group and a to-be-activated filter group are determined in a sound effect module.

Step 602: at least one intermediate transition filter group is determined according to the activation filter group and the to-be-activated filter group.

Step 601 and step 602 are substantially the same as step 101 and step 102, which are not elaborated herein to avoid repetition.

Step 603: the activation filter group I stage-by-stage transitioned to the to-be-activated filter group through the at least one intermediate transition filter group in the sound effect module. In each stage of transition process, the filter group before transition and the filter group after transition perform fade in-out transition according to a preset number of processing frames.

In the transition process from the activation filter group to each stage of the to-be-activated filter group step by step, the filter group before the transition and the filter group after the transition perform the fade in-out transition according to the preset number of processing frames. That is, in each stage of transition process, the number of processing frames of the filter group before the transition and the filter group after the transition are controlled to control the overall transition time. That is, in each stage of transition process, the filter group before the transition and the filter group after the transition jointly process the preset number of processing frames.

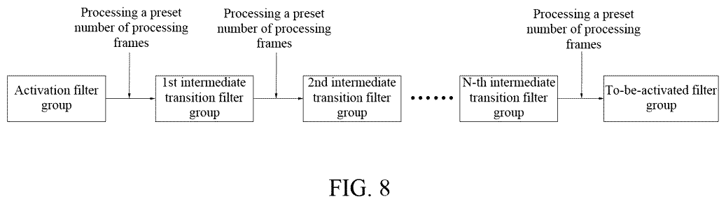

FIG. 8 is a process diagram of an activation filter group transitioning to a to-be-activated filter group through a plurality of intermediate transition filter groups. As described above, stepNum is defined as the number of intermediate filter groups, so other parameters need to be defined to control the transition time for switching. For example, the sampling rate of the audio sequence is 48000 Hz, one frame of audio needs to be processed by the filter group before transition and the filter group after transition in real-time processing, with each frame consisting of 256 sample points, which equals 5.3 ms. In some embodiments, the number of processing frames of each intermediate transition filter group may be controlled to control the overall transition time. For example, each time 45 frames are switched to one intermediate transition filter group. During this period, the filter group before the transition and the filter group after the transition currently performing the transition are kept for filtering processing. Therefore, the overall transition time equals 45*(20+1)*3 ms≈5 s, making the overall transition time of the sound effect controllable.

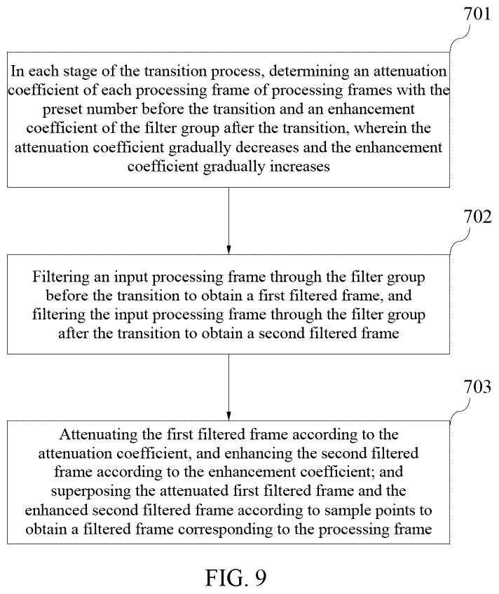

In each stage of transition process in step 603, the filter group before transition and the filter group after transition perform fade in-out transition according to a preset number of processing frames, as shown in FIG. 9, and step 603 includes the following sub-steps.

Step 701: in each stage of the transition process, an attenuation coefficient of each processing frame of processing frames with the preset number before the transition and an enhancement coefficient of the filter group after the transition are determined. The attenuation coefficient gradually decreases and the enhancement coefficient gradually increases.

Step 702: an input processing frame is filtered through the filter group before the transition to obtain a first filtered frame, and the input processing frame is filtered through the the filter group after the transition to obtain a second filtered frame.

Step 703: the first filtered frame is attenuated according to the attenuation coefficient, and the second filtered frame is enhanced according to the enhancement coefficient; and the attenuated first filtered frame and the enhanced second filtered frame are superposed according to sample points to obtain a filtered frame corresponding to the processing frame.

In each stage of the transition process from the activation filter group to the to-be-activated filter group step by step, the filter group before the transition and the filter group after the transition jointly process a preset number of processing frames. The two filters complete the output of the processing frames through the fade in-out mechanism, thereby achieving a smooth transition of the sound effect.

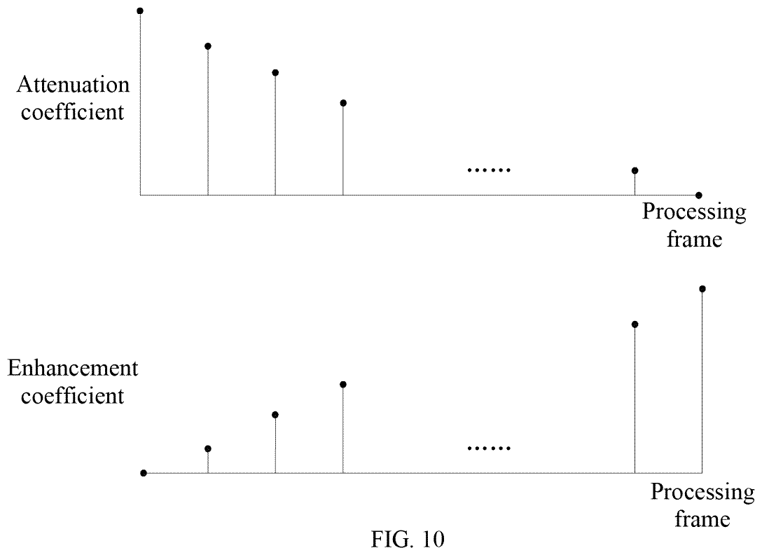

FIG. 10 is a schematic diagram of a fade in-out mechanism performed by two groups of filters on a processing frame in one process of the transition. Switching from the activation filter group to the 1st intermediate transition filter group, from the i-th intermediate transition filter group to the (i+10)-th intermediate transition filter group, and from the N-th intermediate transition filter group to the to-be-activated filter group all use a fade in-out mechanism to prevent the occurrence of amplitude jump to generate POP sound. The fade in-out mechanism of this embodiment is as follows: filtering processing is performed on one of the processing frames by using a group of filters before the transition to obtain a first filtered frame, filtering processing is performed by using a group of filters after the transition to obtain a second filtered frame, fade-out processing is performed on the first filtered frame, fade-in processing is performed on the second filtered frame, and then samples corresponding to the first filtered frame and the second filtered frame after the fade processing are added to obtain a finally output frame.

The upper part of FIG. 10 shows the attenuation coefficient changes of each processing frame in the preset processing frame number by the filter group before the transition. The lower part of FIG. 10 shows the enhancement coefficient changes of each processing frame in the preset processing frame number by the filter group after the transition. It can be seen that as the processing time of frames increases, the attenuation coefficient gradually decreases, the enhancement coefficient gradually increases, the attenuation coefficient linearly decreases, and the enhancement coefficient linearly increases. Each processing frame in the preset number of processing frames corresponds to the attenuation coefficient of the filter group before the transition and the enhancement coefficient of the filter group after the transition. Then each processing frame is filtered through the filter group before the transition to obtain a first filtered frame, and each processing frame is filtered through the filter group after the transition to obtain a second filtered frame. The first filtered frame is attenuated through the attenuation coefficient, and the second filtered frame is enhanced through the enhancement coefficient. A filtered frame corresponding to the processing frame is obtained according to the attenuated first filtered frame and the enhanced second filtered frame. That is, the attenuated first filtered frame and the enhanced second filtered frame are added to obtain a finally output filtered frame, thereby achieving a smooth switching from a group of filters before the transition to a group of filters after the transition.

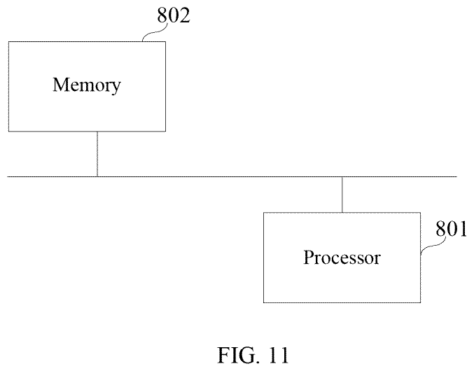

An embodiment of the present disclosure relates to an electronic device. As shown in FIG. 11, the electronic device includes: at least one processor 801; and a memory 802 communicating with the at least one processor 801. The memory stores instructions executable by the at least one processor 801, and the instructions are executed by the at least one processor 801, to enable the at least one processor 801 to perform the sound effect control method described above.

The memory 802 and the processor 801 are connected in a bus manner. The bus can include any number of interconnected buses and bridges, and connect one or more processors 801 and various circuits of the memory 802 together. The bus can also connect various other circuits such as peripherals, voltage regulators, and power management circuits, which are well known in the art. Therefore, it will not be further elaborated herein. The bus interface provides an interface between the bus and the transceiver. The transceiver can be one element, or can be multiple elements, such as multiple receivers and transmitters, providing units for communicating with various other apparatuses over a transmission medium. The data processed by the processor 801 is transmitted over a wireless medium through an antenna, which further receives the data and transmits the data to the processor 801.

The processor 801 is responsible for managing the bus and general processing, and can further provide various functions, including timing, a peripheral interface, voltage regulation, power management, and other control functions. The memory 802 can be used to store data used by the processor when performing operations.

Embodiments of the present disclosure further relates to a computer readable storage medium which stores a computer program. When the computer program is executed by the processor, the foregoing method embodiments are implemented.

That is, those skilled in the art can understand that, all or part of the steps in implementing the method in the above embodiments can be implemented by using a program to instruct related hardware. The program is stored in a storage medium, and includes several instructions used to enable a device (which can be a single-chip microcomputer, a chip, etc.) or a processor to perform all or part of the steps in the methods in the embodiments of the present disclosure. The above storage medium includes various media that can store program codes, such as USB flash drive, mobile hard disk, read-only memory (ROM), random access memory (RAM), magnetic disk, or optical disk.

Those skilled in the art can understand that the above embodiments are specific embodiments for implementing the present disclosure, and various changes can be made in form and detail in practical applications without departing from the spirit and scope of the present disclosure.

What is claimed is:

1. A sound effect control method, comprising:
determining an activation filter group and a to-be-activated filter group in a sound effect module;
determining at least one intermediate transition filter group according to the activation filter group and the to-be-activated filter group; and
stage-by-stage transitioning the activation filter group to the to-be-activated filter group through the at least one intermediate transition filter group in the sound effect module.

2. The sound effect control method as described in claim 1, wherein the determining at least one intermediate transition filter group according to the activation filter group and the to-be-activated filter group, comprises:
obtaining first parameter information of each filter of a same type comprised in the activation filter group and second parameter information of each filter of a same type comprised in the to-be-activated filter group, wherein filters of a same type comprised in the to-be-activated filter group are in a one-to-one correspondence with filters of a same type comprised in the activation filter group;
determining third parameter information of a corresponding filter of the intermediate transitional filter group according to the corresponding first parameter information and second parameter information;
determining each filter of the intermediate transitional filter group in the sound effect module according to the third parameter information; and
the stage-by-stage transitioning the activation filter group to the to-be-activated filter group through the at least one intermediate transition filter group in the sound effect module, comprises:
stage-by-stage transitioning each filter of the activation filter group to a corresponding filter of the to-be-activated filter group through a filter corresponding to at least one of the intermediate transition filter groups.

3. The sound effect control method as described in claim 2, wherein the sound effect module comprises M types of filters, and M is an integer greater than 0; the activation filter group comprises at least one of the M types of filters; the to-be-activated filter group comprises at least one of the M types of filters; and before the obtaining first parameter information of each filter comprised in the activation filter group and second parameter information of each filter comprised in the to-be-activated filter group, the method further comprises:
for one of the filter types, adding a first virtual filter of a same type to the activation filter group when a number of filters comprised in the activation filter group is smaller than a number of filters comprised in the to-be-activated filter group; or, adding a second virtual filter of a same type to the to-be-activated filter group when a number of filters comprised in the activation filter group is greater than a number of filters comprised in the to-be-activated filter group, so that filters of a same type comprised in the to-be-activated filter group are in a one-to-one correspondence with filters of a same type comprised in the activation filter group.

4. The sound effect control method as described in claim 2, wherein the first parameter information comprises a first parameter value of each filter comprised in the activation filter group, and the second parameter information comprises a second parameter value of each filter comprised in the to-be-activated filter group; the third parameter information comprises a third parameter value of each filter comprised in the intermediate transition filter group; and each of the first parameter value, the second parameter value, and the third parameter value is one of a cut-off frequency point, a gain, a Q value, and a filter order; and
the determining third parameter information of a corresponding filter of the intermediate transitional filter group according to the corresponding first parameter information and second parameter information, comprises:
when the first parameter value, the second parameter value, and the third parameter value are all cut-off frequency points, gains, or Q values, for filters corresponding to the activation filter group and the to-be-activated filter group, performing a linear operation or an exponent operation on the first parameter value and the second parameter value according to the number of intermediate filter groups to obtain the third parameter value of the filter corresponding to each of the intermediate transition filter groups.

5. The sound effect control method as described in claim 4, wherein the first parameter information of each filter comprised in the activation filter group comprises different first parameter values, the second parameter information of each filter comprised in the to-be-activated filter group comprises different second parameter values, and the third parameter information of each filter comprised in the intermediate transition filter group comprises different third parameter values.

6. The sound effect control method as described in claim 4, wherein the determining third parameter information of a corresponding filter of the intermediate transitional filter group according to the corresponding first parameter information and second parameter information, further comprises:
for filters corresponding to the activation filter group and the to-be-activated filter group, determining a number of steps required during transition based on a filter order of a filter corresponding to the activation filter group and a filter order of a filter corresponding to the to-be-activated filter group when the first parameter value, the second parameter value, and the third parameter value are all filter orders; and
uniformly dividing, according to the number of steps, corresponding filters in the intermediate filter groups into each step in order or in reverse order based on the size of the step, to determine a filter order of the corresponding filter of each of the intermediate filter groups.

7. The sound effect control method as described in claim 1, wherein the stage-by-stage transitioning the activation filter group to the to-be-activated filter group through the at least one intermediate transition filter group in the sound effect module, comprises:
stage-by-stage transitioning the activation filter group to the to-be-activated filter group through the at least one intermediate transition filter group in the sound effect module; wherein in each stage of transition process, the filter group before transition and the filter group after transition perform fade in-out transition according to a preset number of processing frames.

8. The sound effect control method as described in claim 7, wherein in each stage of transition process, performing the fade in-out transition on the filter group before the transition and the filter group after the transition according to a preset number of processing frames comprises:
in each stage of the transition process, determining an attenuation coefficient of each processing frame of processing frames with the preset number before the transition and an enhancement coefficient of the filter group after the transition, wherein the attenuation coefficient gradually decreases and the enhancement coefficient gradually increases;
filtering an input processing frame through the filter group before the transition to obtain a first filtered frame, and filtering the input processing frame through the filter group after the transition to obtain a second filtered frame; and
attenuating the first filtered frame according to the attenuation coefficient, and enhancing the second filtered frame according to the enhancement coefficient; and superposing the attenuated first filtered frame and the enhanced second filtered frame according to sample points to obtain a filtered frame corresponding to the processing frame.

9. An electronic device, comprising:
at least one processor; and
a memory communicating with the at least one processor;
wherein the memory stores instructions executable by the at least one processor, and the instructions are executed by the at least one processor to enable the at least one processor to perform the sound effect control method as described in claim 1.

10. A computer readable storage medium storing a computer program, wherein the computer program, when executed by a processor, implements the sound effect control method as described in claim 1.
